(19) United States
(12) Patent Application Publication
(10) Pub. No.: US 2007/0194498 A1
(43) Pub. Date: Aug. 23, 2007

(54) Tape reel, tape reel molding apparatus, and method for molding tape reel

(75) Inventor: Katsuki Asano, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/703,659

(22) Filed: Feb. 8, 2007

(30) Foreign Application Priority Data
Feb. 17, 2006 (JP) 2006-040999
Feb. 17, 2006 (JP) 2006-041001
Feb. 28, 2006 (JP) 2006-053194

(51) Int. Cl. B28B 7/10

(52) U.S. Cl. 264/335; 425/436 R

(57) ABSTRACT

A tape reel molding apparatus adapted to be resin-molded by using a molding die, which includes: knockout portions pushing one surface of the tape reel to take the tape reel out of a cavity formed in the molding die after a resin is cooled; and a holding member including: suction portions sucking and holding the other surface of the tape reel pushed out of the cavity; and support portions supporting the suction portions, wherein each of the knockout portions is opposed to each of the suction portions, the tape reel being put between the knockout portions and suction portions.

### BACKGROUND OF THE INVENTION

1. Field of the Invention

The present invention relates to a tape reel, a tape reel molding apparatus and a method for molding a tape reel and, more particularly, to a tape reel, a tape reel molding apparatus and a method for molding a tape reel which is provided in a magnetic tape cartridge and is enabled to prevent an edge of a magnetic tape from being damaged.

2. Background Art

Hitherto, in a magnetic tape cartridge serving as an external recording medium used for backing up data in a computer, a single tape reel around which a magnetic tape is wound is rotatably accommodated in a substantially square flat cartridge case consisting of a lower half-and an upper half. When this magnetic tape cartridge is used, a tape drawing mechanism of a recording/reproducing unit draws the magnetic tape from the cartridge case. Then, the magnetic tape drawn therefrom is reeled on a reel provided in the recording/reproducing unit to run the tape (see JP-A-7-161168 (the term “JP-A” as used herein means an “unexamined published Japanese patent application”)).

The tape reel includes an upper flange which has an opening in the central portion thereof, and also includes a lower flange having a columnar reel hub to be fitted into the opening of the upper flange. The tape reel is manufactured through integral molding by injecting a molten resin into a cavity of a die and also cooling and curing the injected resin.

FIGS. 4A to 4C are explanatory views illustrating a part of the process of molding a tape reel. A cavity 122 is formed in a molding die 121 used to mold a tape reel 102. A knockout portion 123 used to form an opening in the case of forming the upper flange of the tape reel is provided in the die 121. Also, a plurality of knockout pins 124, which are used to take the molded tape reel therefrom after cooled, are formed therein. When the resin-molded tape reel 102 is taken out of the forming die 121 providing the central opening, the knockout pins 124 are advanced from the die 121 toward the tape reel 102, as illustrated in FIG. 4B. Subsequently, the tape reel 102 is separated from the cavity 122 of the die 121 by pushing out the end portions 124a of the knockout pins 124 while causing the end portions 124a thereof. As illustrated in FIG. 4C, the tape reel 102 is held by a holding member 125 while separated from the die 121. The holding member 125 has a plurality of support portions 126 and is configured to hold the tape reel 102 by causing a suction portion provided at end portions of the support portions 126 to be absorbed to the surface of the tape reel 102.

FIG. 5 is a plan view illustrating a tape reel molded in a conventional molding apparatus. As illustrated in FIG. 5, the knockout pins 124 are disposed therein to project out parts that are arranged in the circumferential direction of a tape reel 102 when the tape reel is taken out of the molding die. Because the knockout pins push the tape reel 102 in a state in which the resin is not completely cooled, there is a fear of deformation, such as slight protrusion of the pushed parts of the tape reel 102 toward the opposite surface. When such a deformation occurs in a surface of the tape reel 102 at the side on which a magnetic tape runs, the deformed parts of the tape reel 102 are contact with an edge of the magnetic tape while the tape runs. Thus, the magnetic tape is damaged. The appearance of the wound magnetic tape is deteriorated. There is room for improvement in this respect.

### SUMMARY OF THE INVENTION

The invention is accomplished in view of the above circumstances. An object of the invention is to provide a tape reel molding apparatus and a tape reel molding method that are enabled to prevent occurrence of deformation in a molded tape reel.

(1) According to a first aspect of the invention, a tape reel molding apparatus adapted to be resin-molded by using a molding die, which comprises: knockout portions pushing one surface of the tape reel to take the tape reel out of a cavity formed in the molding die after a resin is cooled; and a holding member including: suction portions sucking and holding the other surface of the tape reel pushed out of the cavity; and support portions supporting the suction portions, wherein each of the knockout portions is opposed to each of the suction portions, respectively, the tape reel being put between the knockout portions and suction portions.

(2) The tape reel molding apparatus as described in the item (1), wherein the support portion comprises a material having a high degree of hardness.

(3) According to a second aspect of the invention, a method for molding tape reel adapted to be resin-molded by using a molding die, which comprises: cooling the resin; putting the tape reel between each of knockout portions and suction portions opposed to face each other; and pushing one surface of the tape reel by the knockout portions to take the tape reel out of a cavity formed in the molding die, while holding the other surface of the tape reel by the suction portions, the suction portions being supported by a support portion provided on a holding member.

(4) The method for molding tape reel as described in the item (3), wherein the support portion comprises a material having a high degree of hardness.

(5) According to a third aspect of the invention, a tape reel molding apparatus adapted to be resin-molded by using a molding die, which comprises: a knockout portion having an end portion having annular shape and pushing one surface of the tape reel to take the tape reel out of a cavity formed in the molding die after a resin is cooled; and a holding member including suction portions sucking the other surface of the tape reel pushed out of the cavity to hold the tape reel.

(6) The tape reel molding apparatus as described in the item (5), wherein the knockout portion is opposed to each of the suction portions, and the tape reel is put between the knockout portion and suction portions.

(7) The tape reel molding apparatus as described in the item (5), wherein the end portion has an annular area contacting with the other surface of the tape reel and having width in a circumstance direction of 0.8 mm or more.

(8) According to a fourth aspect of the invention, a method for molding tape reel adapted to be resin-molded by using a molding die, which comprises: cooling the resin; and pushing one surface of the tape reel by the knockout portions having an annular shape to take the tape reel out of a cavity, while holding the other surface of the tape reel by the suction portions, the suction portions being supported by a support portion provided on a holding member.

(9) The method for molding tape reel as described in the item (8), wherein the knockout portion is opposed to each of the suction portions, and the tape reel is put between the knockout portion and suction portions.

(10) The method for molding tape reel as described in the item (8), wherein the end portion has an annular area contacting with the other surface of the tape reel and having width in a circumstance direction of 0.8 mm or more.

(11) According to a fifth aspect of the invention, a method for molding tape reel adapted to be resin-molded by using a molding die, which comprises: forming an abutment portion on one surface of the tape reel, the abutment portion having thickness being thicker than thicknesses of other parts on one surface thereof by cooling a resin; putting the tape reel between each of knockout portions and suction portions opposed to face each other; and pushing the abutment portion of the tape reel by the knockout portions to take the tape reel out of a cavity formed in the molding die, while holding the other surface of the tape reel by the suction portions, the suction portions being supported by a support portion provided on a holding member.

(12) The tape reel as described in the item (11), wherein the abutment portion has thickness being more than 1.2 times thicknesses of the other parts thereof.

(13) According to a sixth aspect of the invention, a method for molding tape reel adapted to be resin-molded by using a molding die, which comprises: knockout portions pushing an abutment portion provided on one surface of the tape reel to take the tape reel out of a cavity formed in the molding die after a resin is cooled; and a holding member including: suction portions sucking and holding the other surface of the tape reel pushed out of the cavity; and support portions supporting the suction portions, wherein the abutment portion has thickness being thicker than thicknesses of other parts on one surface thereof.

(14) The method for molding tape reel as described in the item (13), wherein the abutment portion has thickness being more than 1.2 times thicknesses of the other parts thereof.

According to the invention, when the molded tape reel is taken out of the molding die, a position, at which each of the knockout portions abuts against one of surfaces of the tape reel, is opposed to a position, at which an associated one of the suction portions sucks the other surface of the tape reel taken out of the cavity, in the tape reel. At that time, even when a load is applied from the knockout portions to the tape reel, a load is similarly applied from the suction portions respectively facing the knockout portions. Then, even in a state in which the resin is not completely cured after cooled, the tape reel can be prevented from being deformed by being pushed by the knockout portions. Thus, an occurrence of deformation of the tape reel can be prevented, so that an edge of the magnetic tape can be prevented from being damaged by being contacted with the tape reel. Also, the appearance of the wound magnetic tape can be prevented from being deteriorated.

Preferably, each of the suction portions is supported by a support portion having a high degree of hardness. Thus, the suction portions respectively facing the knockout portions are supported by the support portions each of which has a higher degree of hardness. The tape reel can more surely be prevented from being deformed due to the load applied from the knockout portions thereto.

The molding apparatus and the molding method according to the invention can set the contact area between the tape reel and the knockout portion, which abuts against the tape reel when the molded tape reel is taken out of the molding die, at a large value. Also, the molding apparatus and the molding method according to the invention can prevent a local load from being applied to the tape reel by being pushed by the projection portions similarly to the conventional molding apparatus. Thus, even in a state in which the resin is not completely cured after cooled, the tape reel can be prevented from being deformed by being pushed by the knockout portion. Consequently, an occurrence of deformation of the tape reel can be prevented, so that the magnetic tape can be prevented from being damaged by causing an edge thereof to be contacted with the tape reel. Also, the appearance of the wound magnetic tape can be prevented from being deteriorated.

In accordance with the molding apparatus and the molding method according to the invention, preferably, a position, at which the knockout portion abuts against one of surfaces of the tape reel, is opposed to a position, at which each of the suction portions sucks the other surface of the tape reel, in the tape reel. Consequently, when the molded tape reel is taken out of the molding die, the position of the knockout portion abutting against the tape reel faces the position, at which each of the suction portions sucks, on the tape reel taken out therefrom. At that time, when a load is applied from the knockout portion to the tape reel, a load is similarly applied from the suction portions respectively facing the knockout portion. Then, even in a state in which the resin is not completely cured after cooled, the tape reel can be prevented from being deformed by being pushed by the knockout portion.

According to the invention, the abutment portion, which is thicker than the other parts of the tape reel, is formed at a part, against which the knockout portions abut when the molded tape reel is taken out of the molding die, in the tape reel. Then, even in a state in which the resin is not completely cured after the resin is cooled, when a load is applied to the tape reel by being pushed by the knockout portions, deformation due to the load can be more absorbed by the abutment portion for a positive difference of the thickness of the abutment portion from that of the other portions of the tape reel. Thus, deformation can be prevented from occurring in a surface opposite to a part against which the knockout portions abut. Consequently, an edge of the magnetic tape can be prevented from being damaged by being contacted with the tape reel. Also, the appearance of the wound magnetic tape can be prevented from being deteriorated.

Preferably, the thickness of the abutment portion is equal to or thicker than 1.2 times the thicknesses of the other parts thereof. Consequently, when a load is applied to the tape reel by causing the knockout portions to push the tape reel, the tape reel can more surely be prevented from being deformed due to the load applied from the knockout portions thereto.

The invention can provide a tape reel, a tape reel molding apparatus and a method for molding tape reel that are enabled to prevent occurrence of deformation in a molded tape reel.

### BRIEF DESCRIPTION OF THE DRAWINGS

The invention disclosed herein will be understood better with reference to the following drawings of which:

FIG. 1 is an exploded perspective view illustrating an embodiment of a magnetic tape cartridge having a tape reel according to a first embodiment of the invention;

FIGS. 2A to 2C are views illustrating a procedure for molding a tape reel according to the first embodiment;

FIG. 3 is a view illustrating-the relationship between the positions of knockout portions and those of suction portions in the tape reel according to the first embodiment;

FIGS. 4A and 4B are views illustrating the configuration of a molding apparatus according to a second embodiment of the invention;

FIGS. 5A to 5C are views illustrating a procedure for molding a tape reel according to the second embodiment;

FIG. 6 is a view illustrating a portion of a tape reel according to the second embodiment, against which a knockout portion abuts;

FIGS. 7A to 7C are views illustrating a procedure for molding a tape reel according to a third embodiment of the invention;

FIG. 8 is a view illustrating the relationship between the positions of knockout portions and those of suction portions in the tape reel according to the third embodiment;

FIGS. 9A to 9C are explanatory views illustrating a part of the process of molding a tape reel; and

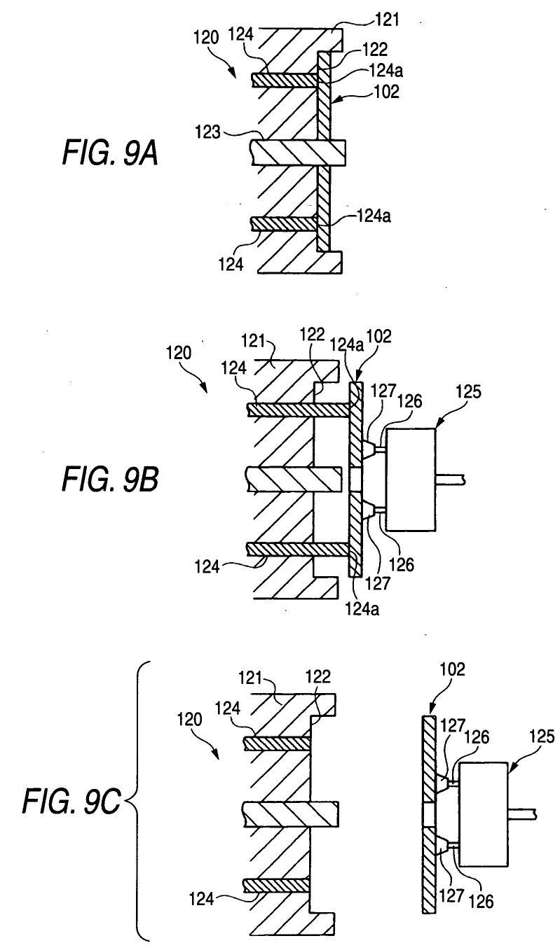

FIG. 10 is a plan view illustrating a tape reel.

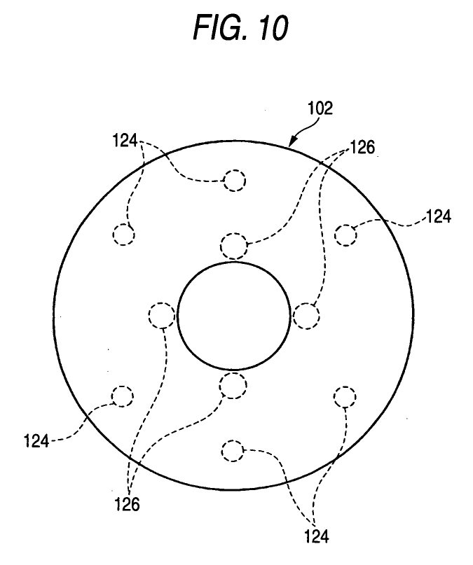

### DETAILED DESCRIPTION OF THE INVENTION

### First Embodiment

Hereinafter, a first embodiment of the invention is described in detail with reference to the accompanying drawings.

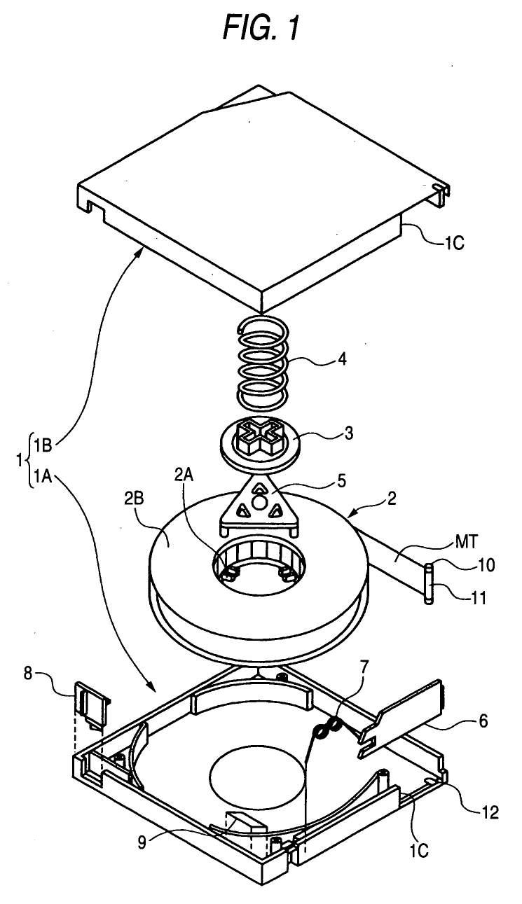

FIG. 1 is an exploded perspective view illustrating the embodiment of a magnetic tape cartridge having a tape reel according to the invention. Incidentally, the tape reel according to the invention is not limited to that provided in the magnetic tape cartridge shown in FIG. 1. The invention can be applied to general tape reels manufactured by resin-molding.

The magnetic tape cartridge shown in FIG. 1 is pursuant to what is called the LTO standard and has a cartridge case 1 constituted by being divided into a lower half part 1A and an upper half part 1B. A single reel 2 around which a magnetic tape MT is preliminarily wound, a lock plate 3 adapted to lock the rotation of the reel 2, a compression coil spring 4 adapted to engage with the upper half part and to push the lock plate 3 against the lower half part 1A, and a release pad 5 adapted to cancel the locked state of the reel 2 are provided in the cartridge case 1.

Also, a sliding door 6 that is provided astride both the lower half part 1A and the upper half part 1B and that is adapted to open and close a magnetic tape outlet 1C, and a torsion coil spring 7 adapted to push the sliding door 6 to a closed position of the magnetic tape outlet 1C are provided in the cartridge case 1.

Also, a safety lug 8 and a cartridge memory chip 9 are incorporated into the cartridge case 1.

The reel 2 has a cup-shaped hub 2A, which is opened to the upper half 1B, at the central portion thereof. The release pad 5, the lock plate 3, and the compression coil spring 4 are serially assembled to the cup-shaped hub 2A. A flange portion 2B is welded to a side of the reel 2, which is provided at the side of the opening of the cup-shaped hub 2A.

Next, the configuration of a molding apparatus for molding a tape reel, and a procedure for molding a tape reel by the molding apparatus are described below.

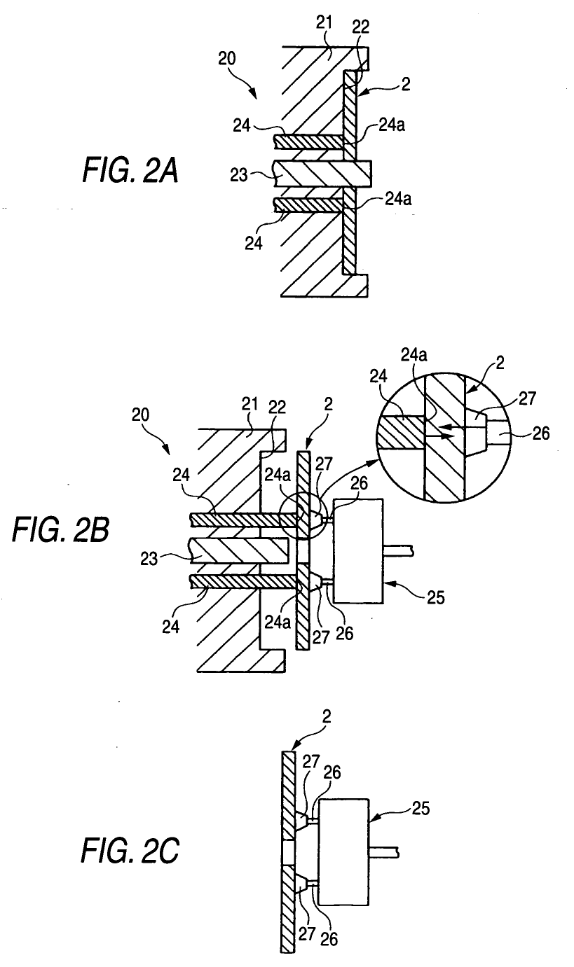

FIGS. 2A to 2C are views illustrating the procedure for molding a tape reel. As shown in FIG. 2A, a molding apparatus 20 has a molding die 21 in which a cavity 22 defining the shape of the tape reel 2 is formed. The molding die 21 is provided with a knockout portion 23, which is used to form a central opening in the tape reel 2, and a plurality of knockout pins (knockout portions) 24 used to take the molded tape reel 2 out of the cavity 22. Also, a cooling channel (not shown), which is used to circulate coolant water when a molten resin is cooled, is formed in the molding die 21. Incidentally, in the present embodiment, the upper flange having a central opening is employed as an example of the tape reel 2. Thus, the present embodiment has the knockout portion 23.

Each of the knockout pins 24 is a substantially cylindrically columnar member and is configured so that the end portion 24a thereof can be advanced to and retreated from the cavity 22 of the molding die 21. When a resin is injected into the cavity 22 and is cooled, each of the knockout pins 24 is retreated to and is fixed at a position at which the end portion 24a thereof is flush with the surface of the cavity 22. When the tape reel 2 is taken out of the cavity 22, each of the knockout pins 24 is controlled so that the end portion 24a thereof is advanced to the cavity 22.

When a resin is injected into the cavity 22, a molten resin is injected thereinto from a resin gate in a state in which the cavity 22 of the molding die 21 is sealed by fitting the die 21 to a counter part die (not shown). After the resin is injected thereinto, the resin is cured by being cooled.

As illustrated in FIG. 2A, when the tape reel 2 is taken out of the cavity 22, the molding die 21 is released to expose one of the surfaces of the tape reel 2 held in the cavity 22. Then, the tape reel 2 is advanced by driving the knockout pins 24 to cause the end portion 24a thereof to abut against the other surface of the tape reel 2. Thus, the tape reel 2 is pushed out in a direction in which the knockout pins 24 are advanced.

As illustrated in FIG. 2A, the tape reel 2 pushed out by the knockout pins 24 is spaced away from the cavity 22 of the molding die 21. At that time, the surface of the tape reel 2, which is opposite to the surface thereof pushed by the knockout pins 24, is held by a holding member 25.

The holding member 25 has a plurality of substantially cylindrically-shaped support portions 26, at the end portion of each of which a sucker-like suction portion 27 is formed. The holding member 25 is configured to hold the tape reel 2 by causing the suction portions 27 to suck one of the surfaces of the tape reel 2. After the tape reel 2 is sucked by the suction portions 27, a molded article is conveyed in a state, in which the tape reel 2 is held, to a position, at which the article is stocked, as illustrated in FIG. 2C.

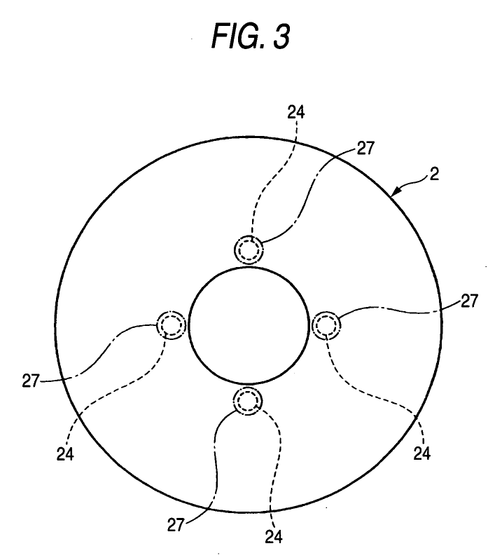

FIG. 3 is a plan view, taken from one of the surfaces of the tape reel 2, to illustrate the relationship between the positions of knockout pins and those of suction portions in the tape reel 2.

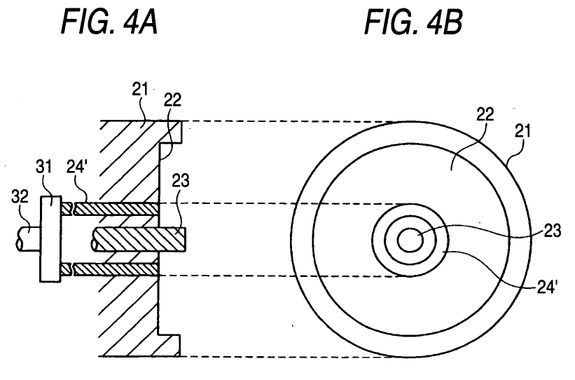

The molding apparatus 20 is also configured so that when the tape reel 2 is pushed out by the knockout pins 24, simultaneously, the tape reel 2 is sucked by the suction portions 27. Then, as illustrated in FIGS. 2B and 4, a position, at which each of the knockout pins 24 abuts against one of surfaces of the tape reel 2, is opposed to a position, at which an associated one of the suction portions 27 sucks the opposite surface of the tape reel 2 taken out of the cavity, in the tape reel. Incidentally, in the present embodiment, both the number of the knockout pins 24 and that of the suction portions 27 are set to be 4. However, a position, at which each of the knockout pins abuts against one of surfaces of the tape reel, is opposed to a position, at which an associated one of the suction portions sucks the other surface of the tape reel taken out of the cavity, in the tape reel are not limited to a specific value, as long as the position, at which each of the knockout pins 24 abuts against one of surfaces of the tape reel 2, is opposed to the position, at which the associated one of the suction portions 27 sucks the opposite surface of the tape reel.

The molding apparatus and the molding method according to the invention are adapted so that when the molded tape reel 2 is taken out of the molding die 21, the position, at which each of the knockout pins 24 abuts against one of surfaces of the tape reel 2, is opposed to the position, at which the associated one of the suction portions 27 sucks the other surface of the tape reel 2. At that time, as illustrated in FIG. 2B, when a load is applied from the knockout pins 24 to the tape reel 2, a load is similarly applied from the suction portions 27 respectively facing the knockout pins 24. Then, even in a state in which the resin is not completely cured after cooled, the tape reel 2 can be prevented from being deformed by being pushed by the knockout pins 24. Thus, an occurrence of deformation of the tape reel 2 can be prevented, so that an edge of the magnetic tape can be prevented from being damaged by being contacted with the tape reel 2. Also, the appearance of the wound magnetic tape can be prevented from being deteriorated.

Preferably, each of the suction portions 27 is supported by a support portion 26 having a high degree of hardness. Thus, the suction portions 27 respectively facing the knockout pins 24 are supported by the support portions 26 each of which has a higher degree of hardness. The tape reel 2 can more surely be prevented from being deformed due to the load applied from the knockout pins 24 thereto. Preferably, the diameter of each of the support portions 26 is set to be larger than that of the end portion 24a of an associated one of the knockout pins 24.

### Second Embodiment

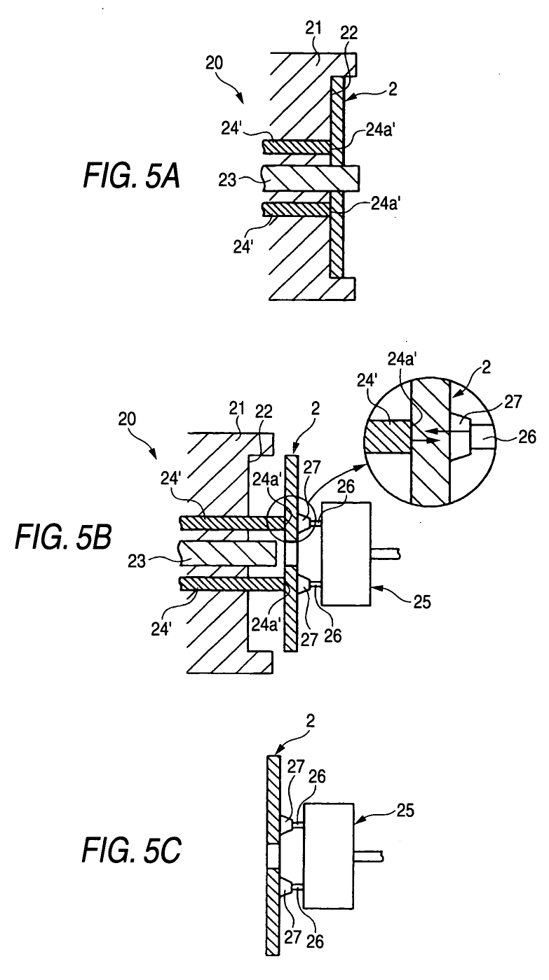

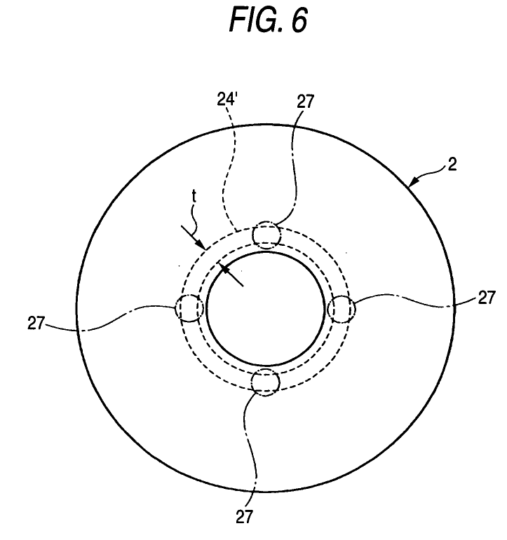

Hereinafter, a second embodiment of the invention is described in detail with reference to the accompanying drawings. FIGS. 4A and 4B are views illustrating the configuration of a molding apparatus according to the present embodiment of the invention. FIGS. 5A to 5C are views illustrating a procedure for molding a tape reel according to the present embodiment. FIG. 6 is a view illustrating a portion of a tape reel according to the present embodiment, against which a knockout portion abuts.

In FIGS. 4A to 6, the same member names and the same reference symbols are affixed to the substantially same members as those in the first embodiment. Therefore, detailed explanation regarding these members will be omitted herein.

The configuration of a molding apparatus for molding a tape reel, and a procedure for molding a tape reel by the molding apparatus according to the second embodiment are described below. As shown in FIGS. 4A and 4B, a molding apparatus 20 has a molding die 21 in which a cavity 22 defining the shape of the tape reel 2 is formed. The molding die 21 is provided with a projection portion 23, which is used to form a central opening in the tape reel 2, and a knockout portion 24′ used to take the molded tape reel 2 out of the cavity 22. Also, a cooling channel (not shown), which is used to circulate coolant water when a molten resin is cooled, is formed in the molding die 21. Incidentally, in the present embodiment, the upper flange having a central opening is employed as an example of the tape reel 2. Thus, the present embodiment has the projection portion 23.

The holding member 25 has a plurality of substantially cylindrically-shaped support portions 26, at the end portion of each of which a sucker-like suction portion 27 is formed. The holding member 25 is configured to hold the tape reel 2 by causing the suction portions 27 to suck one of the surfaces of the tape reel 2. After the tape reel 2 is sucked by the suction portions 27, a molded article is conveyed in a state, in which the tape reel 2 is held, to a position, at which the article is stocked, as illustrated in FIG. 5C.

FIG. 6 is a plan view, taken from one of the surfaces of the tape reel 2, to illustrate a portion of the tape reel 2, against which the knockout portion abuts.

The molding apparatus 20 is also configured so that when the tape reel 2 is pushed out by the knockout portions 24′, simultaneously, the tape reel 2 is sucked by the suction portions 27. Then, as illustrated in FIG. 5B, the knockout portion 24 is formed so that a portion of the surface of the tape reel 2, against which the end portion 24a thereof abuts, is an annular area represented by dashed lines. The annular area is formed so that the circumferences thereof are concentric circles drawn along the circumference of the opening formed in the tape reel 2. At that time, preferably, the width of the annular area (the radial length of the tape reel 2, as viewed in FIG. 6) is equal to or wider than 0.8 mm.

Preferably, a position, at which the knockout portion abuts against one of surfaces of the tape reel, is opposed to a position, at which an associated one of the suction portions sucks the other surface of the tape reel taken out of the cavity, in the tape reel. Incidentally, in the present embodiment, the number of the suction portions 27 is set to be 4. However, the number of the suction portions 27 is not limited to a specific value, as long as the knockout portion 24′ faces the annular area of the tape reel against which the knockout portion 24′ abuts.

The molding apparatus and the molding method according to the invention are adapted so that the shape of a portion of the tape reel 2, against which the end portion 24a′ of the knockout portion 24 abuts when the molded tape reel 2 is taken out of the molding die 21, is set to be annular. Thus, the contact area between the tape reel 2 and the knockout portion 24′, which abuts against the tape reel 2, can be set at a large value. Also, the molding apparatus and the molding method according to the invention can prevent a local load from being applied to the tape reel 2 by being pushed by the projection pins, similarly to the conventional molding apparatus. Thus, even in a state in which the resin is not completely cured after cooled, the tape reel 2 can be prevented from being deformed by being pushed by the knockout portion 24′. Consequently, an occurrence of deformation of the tape reel 2 can be prevented, so that the magnetic tape can be prevented from being damaged by causing an edge thereof to be contacted with the tape reel 2. Also, the appearance of the wound magnetic tape can be prevented from being deteriorated.

Preferably, a position, at which the knockout portion 24 abuts against one of surfaces of the tape reel 2, is opposed to a position, at which each of the suction portions 27 sucks the other surface of the tape reel 2, in the tape reel 2. Consequently, when the molded tape reel 2 is taken out of the molding die 21, the position of the knockout portion 24 abutting against the tape reel 2 faces the position, at which each of the suction portions 27 sucks, on the tape reel 2 taken out therefrom. At that time, when a load is applied from the knockout portion 24 to the tape reel 2, a load is similarly applied from the suction portions 27 respectively facing the knockout portion 24′. Then, even in a state in which the resin is not completely cured after cooled, the tape reel 2 can be prevented from being deformed by being pushed by the knockout portion 24′.

Preferably, each of the suction portions 27 is supported by a support portion 26 having a high degree of hardness. Thus, the suction portions 27 respectively facing the knockout pins 24′ are supported by the support portions 26 each of which has a higher degree of hardness. The tape reel 2 can more surely be prevented from being deformed due to the load applied from the knockout pins 24′ thereto. Preferably, the diameter of each of the support portions 26 is set to be larger than that of the end portion 24a′ of an associated one of the knockout pins 24′.

### Third Embodiment

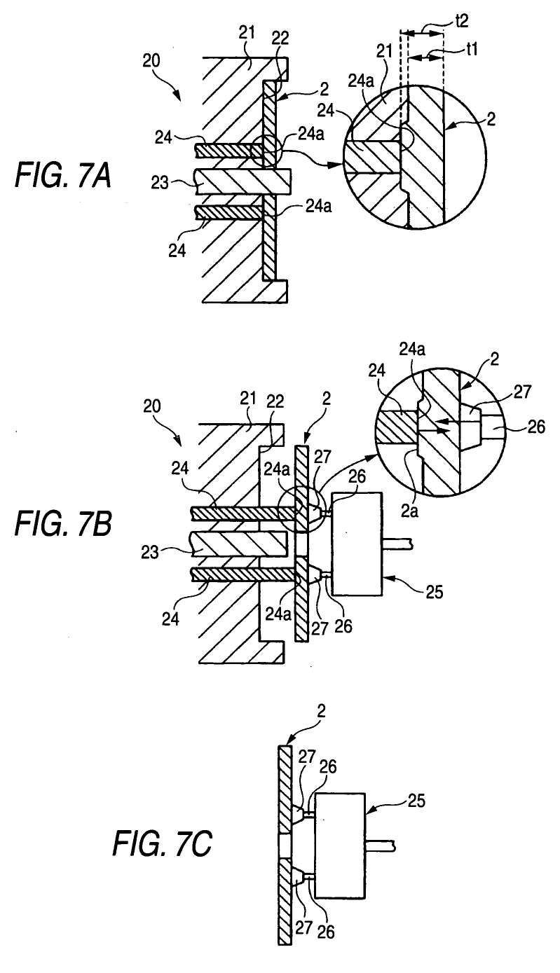

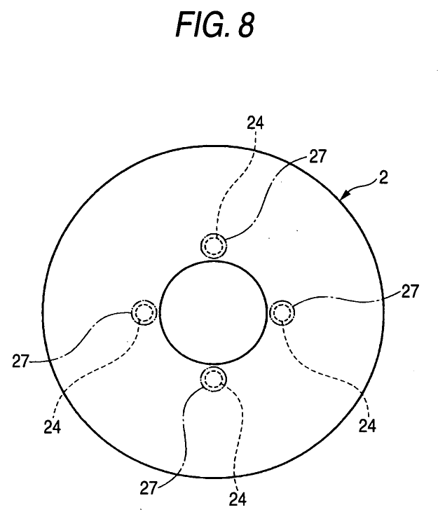

Hereinafter, a second embodiment of the invention is described in detail with reference to the accompanying drawings. FIGS. 7A to 7C are views illustrating a procedure for molding a tape reel according to the present embodiment. FIG. 8 is a view illustrating a portion of a tape reel according to the present embodiment, against which a knockout portion abuts.

In FIGS. 7A to 8, the same member names and the same reference symbols are affixed to the substantially same members as those in the first embodiment. Therefore, detailed explanation regarding these members will be omitted herein.

The molding apparatus 20 is also configured so that when the tape reel 2 is pushed out by the knockout pins 24, simultaneously, the tape reel 2 is sucked by the suction portions 27. Then, as illustrated in FIGS. 7B and 8, a position, at which each of the knockout pins 24 abuts against one of surfaces of the tape reel 2, is opposed to a position, at which an associated one of the suction portions 27 sucks the opposite surface of the tape reel 2 taken out of the cavity, in the tape reel. Incidentally, in the present embodiment, both the number of the knockout pins 24 and that of the suction portions 27 are set to be 4. However, a position, at which each of the knockout pins abuts against one of surfaces of the tape reel, is opposed to a position, at which an associated one of the suction portions sucks the other surface of the tape reel taken out of the cavity, in the tape reel are not limited to a specific value, as long as the position, at which each of the knockout pins 24 abuts against one of surfaces of the tape reel 2, is opposed to the position, at which the associated one of the suction portions 27 sucks the opposite surface of the tape reel.

As illustrated in FIGS. 7A to 7C, and 8, the tape reel 2 according to the present embodiment is configured so that an abutment portion 2a, against which knockout pints abut, is formed on a surface (a left-side surface, as viewed in each of FIGS. 7A to 7C) of the tape reel, which is opposite to a tape running surface thereof, and so that the thickness t2 of the abutment portion 2a is thicker than the thicknesses t1 of other parts thereof. Incidentally, preferably, the thickness t2 of the abutment portion 2a is equal to or thicker than 1.2 times the thicknesses t1 of the other parts thereof.

According to the present embodiment, when the molded tape reel 2 is taken out of the molding die 21, the position, at which each of the knockout pins 24 abuts against one of surfaces of the tape reel 2, is opposed to the position, at which the associated one of the suction portions 27 sucks the tape reel 2. At that time, as illustrated in FIG. 7B, when a load is applied from the knockout pins 24 to the tape reel 2, a load is similarly applied from the suction portions 27 respectively facing the knockout pins 24. Then, even in a state in which the resin is not completely cured after cooled, the tape reel 2 can be prevented from being deformed by being pushed by the knockout pins 24.

Preferably, each of the suction portions 27 is supported by a support portion 26 having a high degree of hardness. Thus, the suction portions 27 respectively facing the knockout pins 24 are supported by the support portions 26 each of which has a higher degree of hardness. The tape reel 2 can more surely be prevented from being deformed due to the load applied from the knockout pins 24 thereto. Preferably, the diameter of each of the support portions 26 is set to be larger than that of the end portion 24a of an associated one of the knockout pins 24.

Thus, in the tape reel 2 according to the invention, the abutment portion 2a being thicker than the other parts of the tape reel 2 is formed at a part of the tape reel 2, against which the knockout pins 24 abut. Then, even in a state in which the resin is not completely cured after the resin is cooled, when a load is applied to the tape reel 2 by being pushed by the knockout pins 24, deformation due to the load can be more absorbed by the abutment portion 2a for a positive difference of the thickness t2 of the abutment portion 2a from that of the other portions of the tape reel 2. Thus, deformation can be prevented from occurring in a surface opposite to a part against which the knockout pins 24 abut. Consequently, an edge of the magnetic tape can be prevented from being damaged by being contacted with the tape reel 2. Also, the appearance of the wound magnetic tape can be prevented from being deteriorated.

The present application claims foreign priority based on Japanese Patent Application (JP 2006-040999) filed Feb. 17 of 2006, Japanese Patent Application (JP 2006-041001) filed Feb. 17 of 2006, Japanese Patent Application (JP 2006-053194) filed Feb. 28 of 2006, the contents of which is incorporated herein by reference.

What is claimed is:

1. A tape reel molding apparatus adapted to be resin-molded by using a molding die, which comprises:
knockout portions pushing one surface of the tape reel to take the tape reel out of a cavity formed in the molding die after a resin is cooled; and
a holding member including:
suction portions sucking and holding the other surface of the tape reel pushed out of the cavity; and
support portions supporting the suction portions,
wherein
each of the knockout portions is opposed to each of the suction portions, the tape reel being put between the knockout portions and suction portions.

2. The tape reel molding apparatus as claimed in claim 1, wherein the support portion comprises a material having a high degree of hardness.

3. A method for molding tape reel adapted to be resin-molded by using a molding die, which comprises:
cooling the resin;
putting the tape reel between each of knockout portions and suction portions opposed to face each other; and
pushing one surface of the tape reel by the knockout portions to take the tape reel out of a cavity formed in the molding die, while holding the other surface of the tape reel by the suction portions, the suction portions being supported by a support portion provided on a holding member.

4. The method for molding tape reel as claimed in claim 3, wherein the support portion comprises a material having a high degree of hardness.

5. A tape reel molding apparatus adapted to be resin-molded by using a molding die, which comprises:
a knockout portion having an end portion having annular shape and pushing one surface of the tape reel to take the tape reel out of a cavity formed in the molding die after a resin is cooled; and
a holding member including suction portions sucking the other surface of the tape reel pushed out of the cavity to hold the tape reel.

6. The tape reel molding apparatus as claimed in claim 5, wherein the knockout portion is opposed to each of the suction portions, and the tape reel is put between the knockout portion and suction portions.

7. The tape reel molding apparatus as claimed in claim 5, wherein the end portion has an annular area contacting with the other surface of the tape reel and having width in a circumstance direction of 0.8 mm or more.

8. A method for molding tape reel adapted to be resin-molded by using a molding die, which comprises:
cooling the resin; and
pushing one surface of the tape reel by the knockout portions having an annular shape to take the tape reel out of a cavity, while holding the other surface of the tape reel by the suction portions, the suction portions being supported by a support portion provided on a holding member.

9. The method for molding tape reel as claimed in claim 8, wherein the knockout portion is opposed to each of the suction portions, and the tape reel is put between the knockout portion and suction portions.

10. The method for molding tape reel as claimed in claim 8, wherein the end portion has an annular area contacting with the other surface of the tape reel and having width in a circumstance direction of 0.8 mm or more.

11. A method for molding tape reel adapted to be resin-molded by using a molding die, which comprises:
forming an abutment portion on one surface of the tape reel, the abutment portion having thickness being thicker than thicknesses of other parts on one surface thereof by cooling a resin;
putting the tape reel between each of knockout portions and suction portions opposed to face each other; and
pushing the abutment portion of the tape reel by the knockout portions to take the tape reel out of a cavity formed in the molding die, while holding the other surface of the tape reel by the suction portions, the suction portions being supported by a support portion provided on a holding member.

12. The tape reel as claimed in claim 11, wherein the abutment portion has thickness being more than 1.2 times thicknesses of the other parts thereof.

13. A method for molding tape reel adapted to be resin-molded by using a molding die, which comprises:
knockout portions pushing an abutment portion provided on one surface of the tape reel to take the tape reel out of a cavity formed in the molding die after a resin is cooled; and
a holding member including:
suction portions sucking and holding the other surface of the tape reel pushed out of the cavity; and
support portions supporting the suction portions,
wherein
the abutment portion has thickness being thicker than thicknesses of other parts on one surface thereof.

14. The method for molding tape reel as claimed in claim 13, wherein the abutment portion has thickness being more than 1.2 times thicknesses of the other parts thereof.
